(19) United States
(12) Patent Application Publication
(10) Pub. No.: US 2024/0214282 A1
(43) Pub. Date: Jun. 27, 2024

(54) TRAFFIC STEERING FOR SERVICE FUNCTION CHAINING (SFC) IN NEXT GENERATION CELLULAR NETWORKS

(71) Applicant: Intel Corporation, Santa Clara, CA (US)

(72) Inventors: Zongrui Ding, Portland, OR (US); Qian Li, Beaverton, OR (US); Sangeetha L. Bangolae, Portland, OR (US); Youn Hyoung Heo, Sunnyvale, CA (US); Abhijeet Ashok Kolekar, Hillsboro, OR (US); Ching-YU Liao, Hillsboro, OR (US); Thomas Luetzenkirchen, Taufkirchen (DE); Sudeep K. Palat, Cheltenham (GB); Alexandre Saso Stojanovski, Paris (FR); Xiaopeng Tong, Beijing (CN)

(21) Appl. No.: 18/287,943

(22) PCT Filed: Sep. 1, 2022
(86) PCT No.: PCT/US2022/042368

§ 371 Date: Oct. 23, 2023

Related U.S. Application Data
(60) Provisional application No. 63/240,315, filed on Sep. 2, 2021.

(51) Int. Cl. H04L 41/5054; H04L 45/00

(52) U.S. Cl. CPC H04L 41/5054; H04L 45/34

(57) ABSTRACT

An apparatus and system for traffic Steering for Service Function Chaining (SFC) are described. Different protocol stacks may be used to enable SFC for the user plane. The protocol stacks include: separate SFC service layer and transport protocols in which transport uses identifiers of different enhanced user plane functions (eUPFs) and communication (Comm) Service Functions (SFs), transport protocols that are integrated with SFC-related information in which a General Packet Radio Service Tunneling Protocol-user (GTP-U) header or a Segment Routing Header (SRH) has type-length-value (TLV) fields contains the SFC-related information, or an SFC inherent Segment Routing (SR) protocol stack in which first SFC-related information is carried as a locator: function field in Segment Routing Header (SRH) and second SFC-related information is contained in a type-length-value (TLV) field of the SRH, the first SFC-related information comprising a Comm SF and identification of SFs reachable from the Comm SF.

### PRIORITY CLAIM

This application claims the benefit of priority to U.S. Provisional Patent Application Ser. No. 63/240,315, filed Sep. 2, 2021, which is incorporated herein by reference in its entirety.

### TECHNICAL FIELD

Embodiments pertain to next generation (NG) wireless networks. In particular, some embodiments relate to Service Function Chaining (SFC) in new radio (NR) wireless systems.

### BACKGROUND

The use and complexity of NG or NR wireless systems, which include 5G networks and are starting to include sixth generation (6G) networks among others, has increased due to both an increase in the types of devices user equipment (UEs) using network resources as well as the amount of data and bandwidth being used by various applications, such as video streaming, operating on these UEs. With the vast increase in number and diversity of communication devices, the corresponding network environment, including routers, switches, bridges, gateways, firewalls, and load balancers, has become increasingly complicated. As expected, a number of issues abound with the advent of any new technology, including complexities related to edge computing.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a 6G architecture for SFC in accordance with some embodiments.

FIG. 4 illustrates a user plane protocol stack for an independent SFC service layer and transport in accordance with some embodiments.

FIG. 5 illustrates packet filters in an enhanced user plane function (eUPF) for SFC in accordance with some embodiments.

FIG. 6 illustrates a method of a subscriber management function (SMF) setting up an SFC packet filter and SF forwarding rules in accordance with some embodiments.

FIG. 7 illustrates a method for setting up a SFC packet filter and SF forwarding rules in accordance with some embodiments.

FIG. 8 illustrates packet filters in an eUPF for SFC in accordance with some embodiments.

FIG. 9 illustrates a General Packet Radio Service (GPRS) Tunneling Protocol (GTP)-user (U) header with SFC in accordance with some embodiments.

FIG. 10 illustrates a Segment Routing Header (SRH) with SFC in accordance with some embodiments.

FIG. 11 illustrates a user plane stack for SFC inherent SR in accordance with some embodiments.

FIG. 12 illustrates a packet format for SFC inherent Segment Routing (SR) in accordance with some embodiments.

FIG. 13 illustrates a label configuration for SFC inherent SR in accordance with some embodiments.

FIG. 14 illustrates a method of providing traffic steering information in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

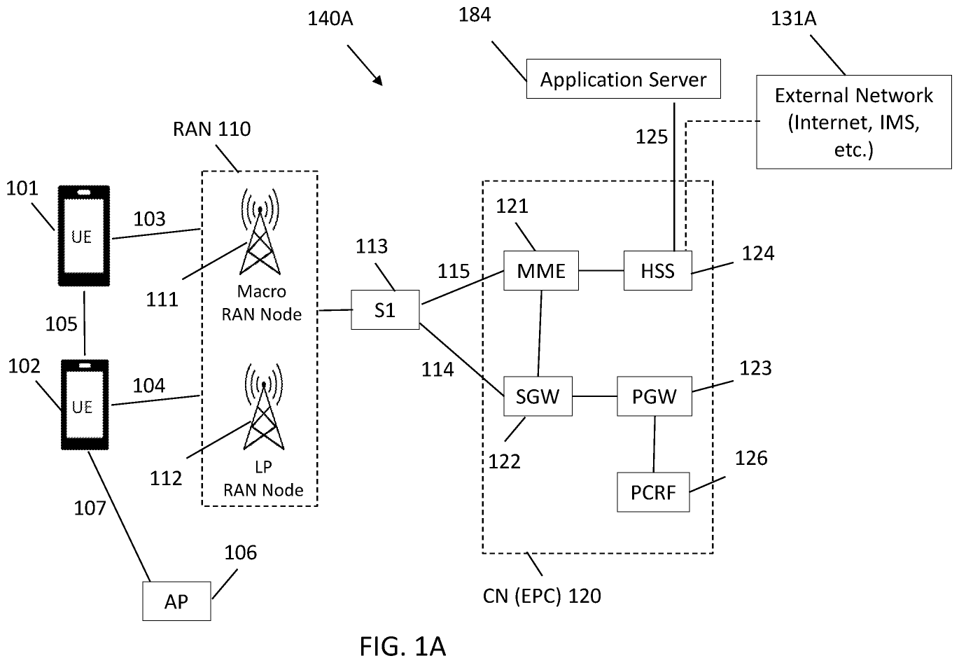

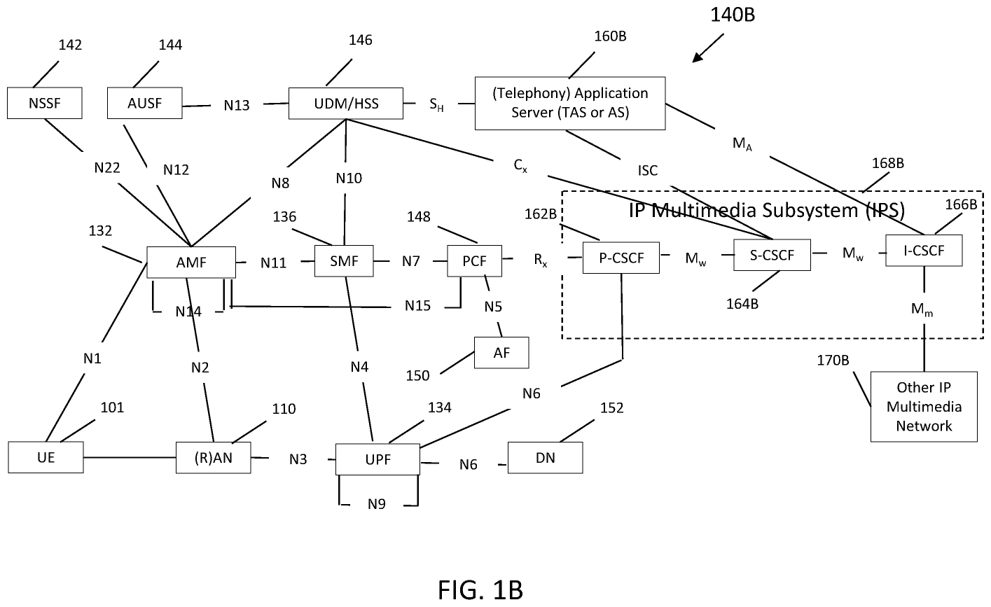

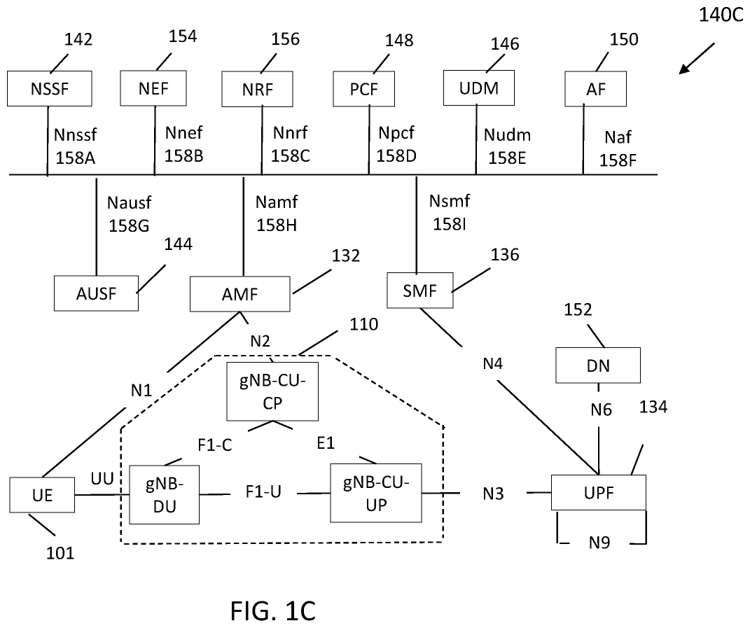

FIG. 1A illustrates an architecture of a network in accordance with some aspects. The network 140A includes 3GPP LTE/4G and NG network functions that may be extended to 6G and later generation functions. Accordingly, although 5G will be referred to, it is to be understood that this is to extend as able to 6G (and later) structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHZ, and other frequencies and Spectrum Access System (SAS) in 3.55-3.7 GHZ and other frequencies).

Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IOT) UE or a Cellular IoT (CIOT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IOT (eNB-IOT) UE and Further Enhanced (FeNB-IOT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The RAN 110 may contain one or more gNBs, one or more of which may be implemented by multiple units. Note that although gNBs may be referred to herein, the same aspects may apply to other generation NodeBs, such as 6^{th} generation NodeBs—and thus may be alternately referred to as Radio Access Network NodeB (xNB).

Each of the gNBs may implement protocol entities in the 3GPP protocol stack, in which the layers are considered to be ordered, from lowest to highest, in the order Physical (PHY), Medium Access Control (MAC), Radio Link Control (RLC), Packet Data Convergence Control (PDCP), and Radio Resource Control (RRC)/Service Data Adaptation Protocol (SDAP) (for the control plane/user plane). The protocol layers in each gNB may be distributed in different units—a Central Unit (CU), at least one Distributed Unit (DU), and a Remote Radio Head (RRH). The CU may provide functionalities such as the control the transfer of user data, and effect mobility control, radio access network sharing, positioning, and session management, except those functions allocated exclusively to the DU.

The higher protocol layers (PDCP and RRC for the control plane/PDCP and SDAP for the user plane) may be implemented in the CU, and the RLC and MAC layers may be implemented in the DU. The PHY layer may be split, with the higher PHY layer also implemented in the DU, while the lower PHY layer is implemented in the RRH. The CU, DU and RRH may be implemented by different manufacturers, but may nevertheless be connected by the appropriate interfaces therebetween. The CU may be connected with multiple DUs.

The interfaces within the gNB include the E1 and front-haul (F) F1 interface. The E1 interface may be between a CU control plane (gNB-CU-CP) and the CU user plane (gNB-CU-UP) and thus may support the exchange of signaling information between the control plane and the user plane through E1AP service. The E1 interface may separate Radio Network Layer and Transport Network Layer and enable exchange of UE associated information and non-UE associated information. The E1AP services may be non UE-associated services that are related to the entire E1 interface instance between the gNB-CU-CP and gNB-CU-UP using a non UE-associated signaling connection and UE-associated services that are related to a single UE and are associated with a UE-associated signaling connection that is maintained for the UE.

The F1 interface may be disposed between the CU and the DU. The CU may control the operation of the DU over the F1 interface. As the signaling in the gNB is split into control plane and user plane signaling, the F1 interface may be split into the F1-C interface for control plane signaling between the gNB-DU and the gNB-CU-CP, and the F1-U interface for user plane signaling between the gNB-DU and the gNB-CU-UP, which support control plane and user plane separation. The F1 interface may separate the Radio Network and Transport Network Layers and enable exchange of UE associated information and non-UE associated information. In addition, an F2 interface may be between the lower and upper parts of the NR PHY layer. The F2 interface may also be separated into F2-C and F2-U interfaces based on control plane and user plane functionalities.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrow band-IoT (NB-IOT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a core network (CN) 120. The NG-RAN 110 can include a plurality of nodes, such as gNBs and NG-eNBs. The CN 120 (e.g., a 5G core network (5GC)) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other CN network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g. an IMS operated by a different network operator.

In some aspects, the UDM/HSS 146 can be coupled to an application server (AS) 160B, which can include a telephony application server (TAS) or another application server. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

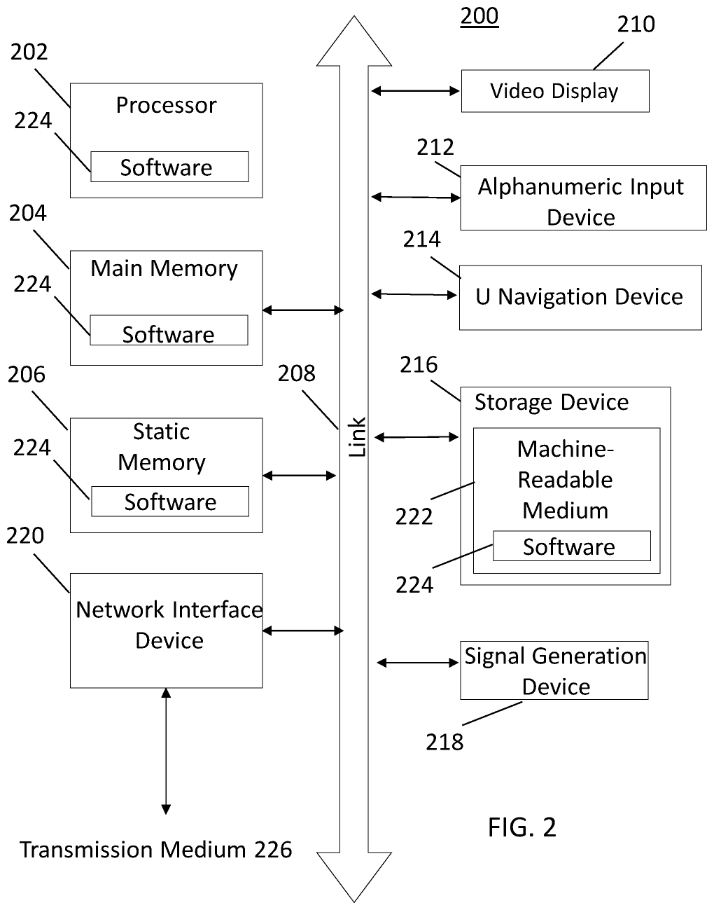

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices: magnetic disks, such as internal hard disks and removable disks: magneto-optical disks: Random Access Memory (RAM): and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety re-lated applications in the frequency range 5,875 GHz to 5,905 GHz), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHZ, 3.6-3.8 GHZ and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHZ, 1710-2025 MHz, 2110-2200 MHz, 2300-2400 MHZ, 2.4-2.4835 GHz (note: it is an ISM band with global availability and it is used by Wi-Fi technology family (11b/g/n/ax) and also by Bluetooth), 2500-2690 MHz, 698-790 MHZ, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHZ, 31-31.3 GHZ, 37-38.6 GHZ, 38.6-40 GHz, 42-42.5 GHZ, 57-64 GHz, 71-76 GHz, 81-86 GHz and 92-94 GHZ, etc), the ITS (Intelligent Transport Systems) band of 5.9 GHZ (typically 5.85-5.925 GHz) and 63-64 GHZ, bands currently allocated to WiGig such as WiGig Band 1 (57.24-59.40 GHz), WiGig Band 2 (59.40-61.56 GHZ) and WiGig Band 3 (61.56-63.72 GHZ) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHZ, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., lowithmedium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

5G networks extend beyond the traditional mobile broadband services to provide various new services such as internet of things (IOT), industrial control, autonomous driving, mission critical communications, etc. that may have ultra-low latency, ultra-high reliability, and high data capacity requirements due to safety and performance concerns. Some of the features in this document are defined for the network side, such as APs, eNBs, NR or gNBs
note that this term is typically used in the context of 3GPP 5G and 6G communication systems, etc. Still, a UE may take this role as well and act as an AP, eNB, or gNB: that is some or all features defined for network equipment may be implemented by a UE.

As above, SFC enables the creation of composite (network) services that include an ordered set of service functions (SFs) to be applied to packets and/or frames and/or flows selected as a result of classification. The SFC involves the traffic path as well as an ordered list of SFs in the traffic path. After the classification, the packets or traffic are steered following the SFC path with the correct order of the SFs. Segment Routing (SR) is a source routing paradigm that explicitly indicates the forwarding path for packets at the ingress node by inserting an ordered list of instructions, called segments. When segment routing is deployed on a MultiProtocol Label Switching (MPLS) dataplane, the segment routing is called SR-MPLS (RFC 8660). When segment routing is deployed on IPV6 dataplane, the segment routing is called SRv6 (rfc 8986). In data centers and core networks, SR is widely used for SFC because SR simplifies the network state of the SFC path and SFs.

In cellular network, the current user plane protocol is GTP-U, which creates a tunnel between the gNB and an anchor UPF for the user plane traffic. Additional information is used to enable SFC based on the current architecture. Furthermore, other options may be used to enable SFC with an enhanced user plane protocol stack for 5G beyond networks, which are more cloud native and efficient. Discussed herein are: SFC enablement with the current 5G network, SFC enablement with enhanced user plane protocol stacks, e.g., with SR, information and packet format to be standardized for 5G network or beyond based on different user plane protocol stacks, and the SFC related information configuration to the related entities.

Three protocol stack options may be used to enable SFC for user plane: 1) separate SFC service layer and transport, 2) integrated SFC service layer and transport, or 3) SR inherent SFC. Based on these different options, the configuration to the eUPF/Communication (Comm) SF are enabled and modification to the GTP-U and SRv6 protocols may be applied.

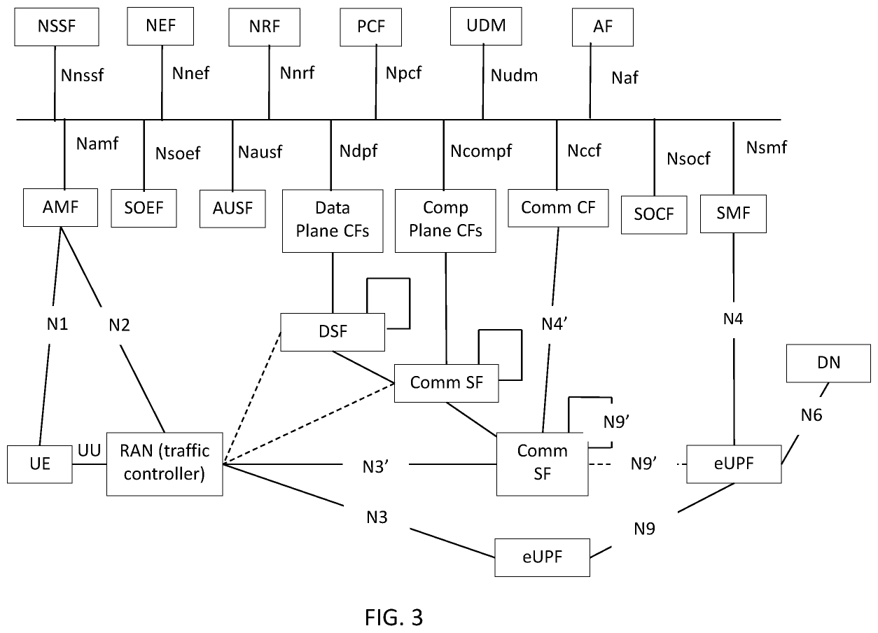

FIG. 3 illustrates a 6G architecture for SFC in accordance with some embodiments. The 6G architecture shown in FIG. 3 may have a Service Orchestration and Chaining Function (SOCF) to orchestrate and configure the SFC. A traffic classifier can be in the xNB or eUPF to apply the related configurations for SFC to the traffic/packets. The mechanisms of steering the traffic through different options of user plane protocol stacks are discussed below. The Service Orchestration and Exposure Function (SOEF), which controls exposure of the SFC orchestration service of SOCF to external entities, is also present in FIG. 3.

### SFC Service Layer

The SFC service layer is a protocol layer above the SFC transport layer. The SFC service layer holds the SFC-related information such as path information and ordered list of SFs. An example of a SFC service layer is the Network Service Header (NSH) defined in RFC 8300. The SFC service layer can provide SFC encapsulation, such as by generating an encapsulation header. The SFC encapsulation includes, but not limited to, the following information: Service ID; the ordered list of SFs, such as a list of the SF names, addresses (e.g., IP addresses), SF service name, Fully Qualified Domain Names (FQDNs), etc.; the SFC path information such as the identifiers of the path transport end points (e.g., IP address, TEID), a network slice ID Single—Network Slice Selection Assistance Information (S-NSSAI): and the current serving SF identifier such as SF names, addresses (e.g., IP addresses), SF service name, FQDNs, etc. The service layer encapsulation can use existing or future protocols. Based on the following user plane protocol stacks, the SFC service layer header can be in different forms.

### Traffic Steering Rules

The traffic steering rules include the following for an entity to decide how to steer the traffic through the network based on local information: the identifiers of the destination of each forwarding such as IP addresses/port number, domain name, SF names, FQDNs, S-NSSAI, TEID, etc.; whether to skip a SF based on network status, e.g., network congestion: whether to split the traffic to different SF instances based on network status: and the next function such as an eUPF or Comm SF to steer traffic along the SFC path.

### Traffic Steering Schemes for SFC

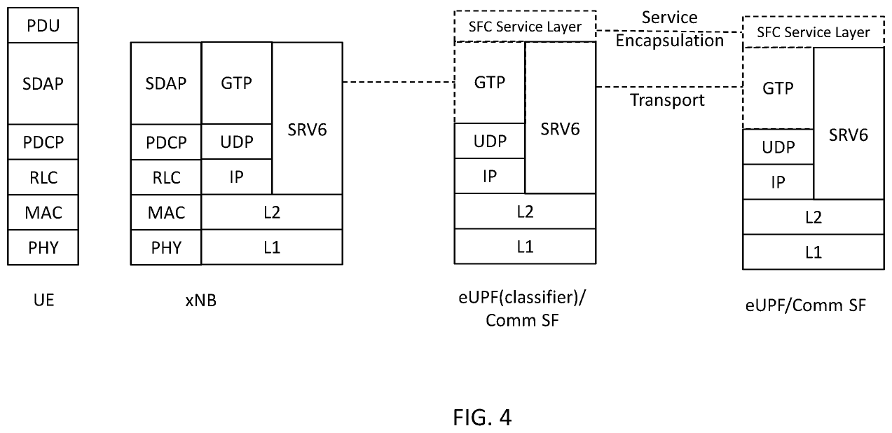

Option 1: Traffic steering with separate SFC service layer and transport. FIG. 4 illustrates a user plane protocol stack for an independent SFC service layer and transport in accordance with some embodiments. The eUPF and/or Comm SF may be the classifier. In this option, the SFC service layer is independent of the underlying transport network. Therefore, this option can accommodate different transport network/protocols such as GTP-U, SRv6, etc. as shown in FIG. 4, where dual stacks of GTP-U and SRv6 are in xNB, eUPFs and Comm SFs. The 5G user plane is an example of GTP-U based transport, and the UPF is enhanced with the SFC service layer awareness (named eUPF). The 6G Comm SF can support SRv6 as a transport. There are one or more eUPF/Comm SFs in a SFC path.

Option1.1: SFC service aware packet filters in eUPF/Up Link Classifier (ULCL). In this option, the SFC service layer is at the packet data unit (PDU) layer and a SFC packet filter can be set up to filter and steer the traffic, as shown in FIG. 4.

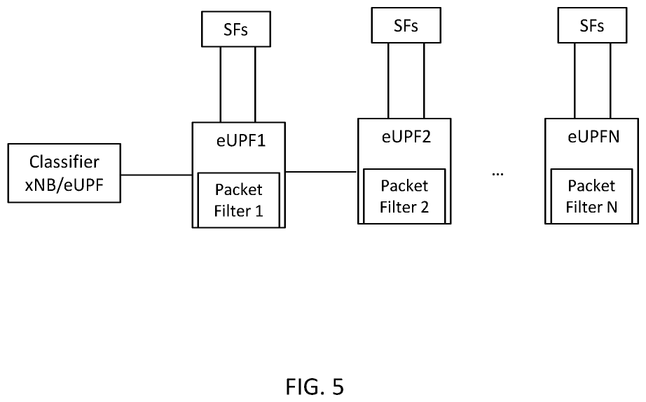

FIG. 5 illustrates packet filters in an enhanced user plane function (eUPF) for SFC in accordance with some embodiments. To steer traffic along the SFC path with eUPFs, packet filters can be set up with the criteria on SFC. These SFC packet filters can be configured at the time of setting up SFC service or PDU sessions. Different packet filters can be configured into different eUPFs to steer the traffic through the SFs that are reachable from the eUPF as shown in FIG. 5.

The SFC packet filter is based on the combination of the following: any information in the SFC service layer as described in 5.1.2 such as service ID, ordered list of SFs or a segment of the list, the state of the SFC such as the current or next SF: transport identifiers for the traffic path such as a series of TEIDs: Source/destination IP address or IPv6 prefix: Source/destination port number: Protocol ID of the protocol above IP/Next header type: Type of Service (TOS) (IPv4)/Traffic class (IPv6) and Mask: Flow Label (IPv6): Security parameter index: and Packet Filter direction.

The SFC path and the list of SFs reachable from an eUPF can be set up from the SMF by the SOCF through N4 interface. Therefore, the SFC service layer encapsulation can only include minimum information about the SFC service such as a service ID and current SF indicator similar to NSH. The SFC service ID identifies the SFC service profile and the SFC service context.

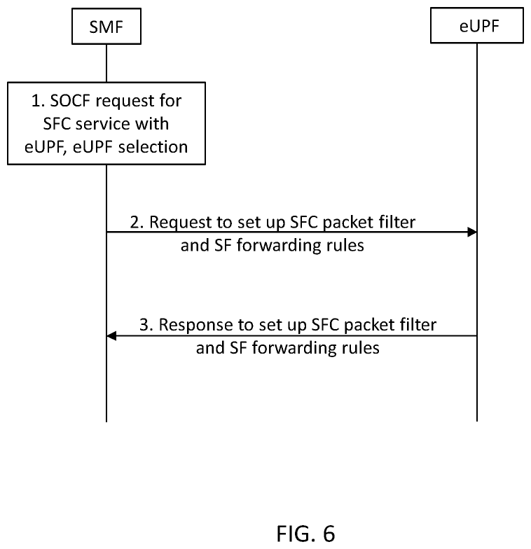

FIG. 6 illustrates a method of a SMF setting up an SFC packet filter and SF forwarding rules in accordance with some embodiments. The procedure to set up and configure eUPFs/ULCL with SFC packet filter and traffic steering rules are shown in FIG. 6.

In FIG. 6, at operation 1) the SOCF requests the SMF to configure SFC service with the eUPFs. This operation includes the requirements on SFC service such as the description of the SFC path with geographically information, the requirements on how to forward the traffic to the SFs reachable from the eUPF. The SMF can perform eUPF selection based on the SOCF requirements and the NRF.

At operation 2) the SMF sends a request to eUPF to set up the SFC packet filter as described in 5.1.2 and the traffic forwarding rules to the SFs as described in 5.1.3. In one embodiment, the xNB can map the SDAP entity to the tunnel endpoint identifier (TEID) towards the first eUPF in the SFC path. Then the subsequent eUPF can apply the packet filter and traffic rules to the SFC user plane traffic. Specifically, the SFC user plane traffic is filtered by the SFC service layer encapsulation such as a path ID or a service ID. The traffic forwarding rule can include a list of ordered SF identifiers which can be reachable from the eUPF. Then, based on the next SF's identifier such as an IP address, the eUPF sends the SFC traffic to the SF. Once the SF processes the traffic, the SF sends the traffic back to the eUPF, which can perform a packet filter again and steer traffic to the next SF. When the end of the ordered SF list is reached, the eUPF can send the traffic to another eUPF based on the context information configured in the eUPF, such as the next eUPF's identifiers, e.g., a TEID.

At operation 3) the eUPF sends a response to the SMF to indicate whether the packet filter and forwarding rules are set up successfully. If the setup has failed, the eUPF may include a cause in the response.

Option 1.2 SFC Service Aware Packet Filters in Comm SF with SR as Transport

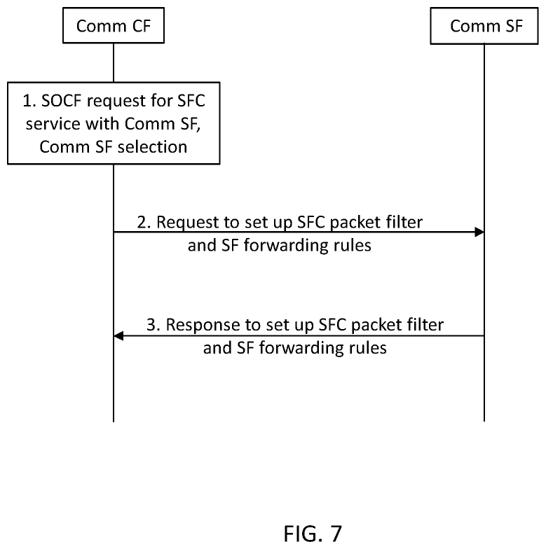

FIG. 7 illustrates a method for setting up a SFC packet filter and SF forwarding rules in accordance with some embodiments. For a Comm SF-based SFC with separate SFC service layer and transport, the design of a packet filter and SFC service layer encapsulation is similar. However, the transport identifiers are SR labels instead of TEIDs in Option 1.1. The SR labels are used to provide tunneling between Comm SFs and configured during the SFC setup phase to the Comm SFs by Comm Control function (CF) as shown in FIG. 7.

The procedures are very similar to those in FIG. 6. The differences include that the protocol between the SMF/eUPF is generally considered as Packet Forwarding Control Protocol (PFCP) on the N4 interface, while the protocols between the Comm CF/SF can be PFCP, Path Computation Element Protocol (PCEP), OpenFlow, Netconf or other protocols. In addition, instead of TEID to identify a GTP-U tunnel, the SR labels such as SR-MPLS or SRv6 labels are used to identify a SR based tunnel.

Option 2: Traffic Steering with Integrated SFC and Transport

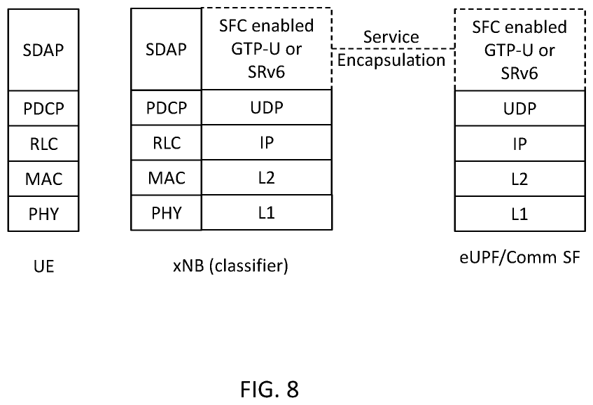

FIG. 8 illustrates packet filters in an eUPF for SFC in accordance with some embodiments. In this option, the transport network protocol is integrated with the SFC service layer as shown in FIG. 8.

Option 2.1 Integrated SFC with GTP-U

In this option, the GTP-U is modified to be SFC aware so that the GTP-U is able to identify the SFC related information such as a service ID or current SF, etc. from the GTP-U header, which are carried as GTP-U extended headers.

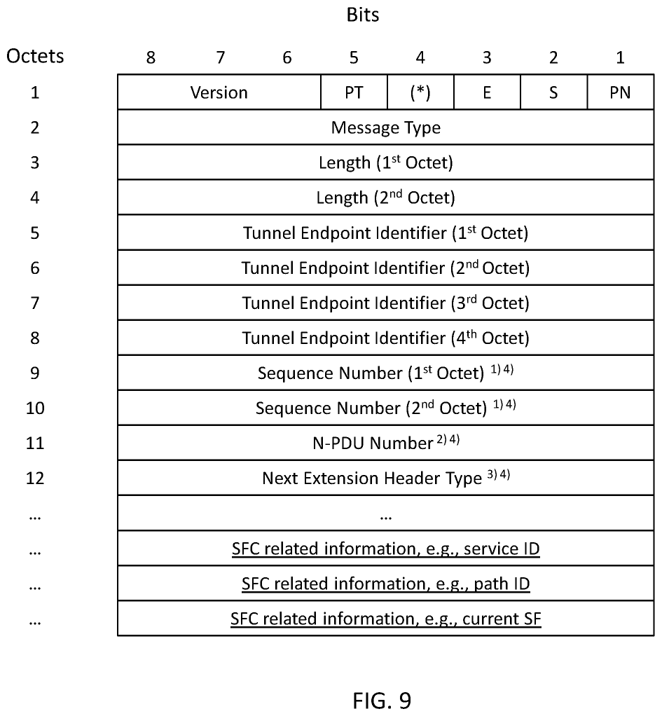

FIG. 9 illustrates a GTP-U header with SFC in accordance with some embodiments. The modified GTP-U header shown in FIG. 9 with additional octets underlined (The GTP-U header is defined in 3GPP TS 29.281). That is, as shown, the SFC service layer encapsulation can be included as an extended header at Octet 12 and beyond. As indicated, (*) is a spare bit that is sent as ‘0’ and is not evaluated by the receiver. The numbering in the fields indicate that: 1) the field is only evaluated when indicated by the S flag set to 1; 2) the field is only evaluated when indicated by the PN flag set to 1: 3) the field is only evaluated when indicated by the E flag set to 1: 4) the field is present if and only if any one or more of the S, PN and E flags are set.

In this case, use of SFC encapsulation or packet filter may be avoided. The eUPF receives the GTP-U packet and forwards the upper layer PDU based on the configured SFC context and path information following the procedure in FIG. 6 to the reachable SFs at that eUPF.

Option 2.2 Integrated SFC with SR

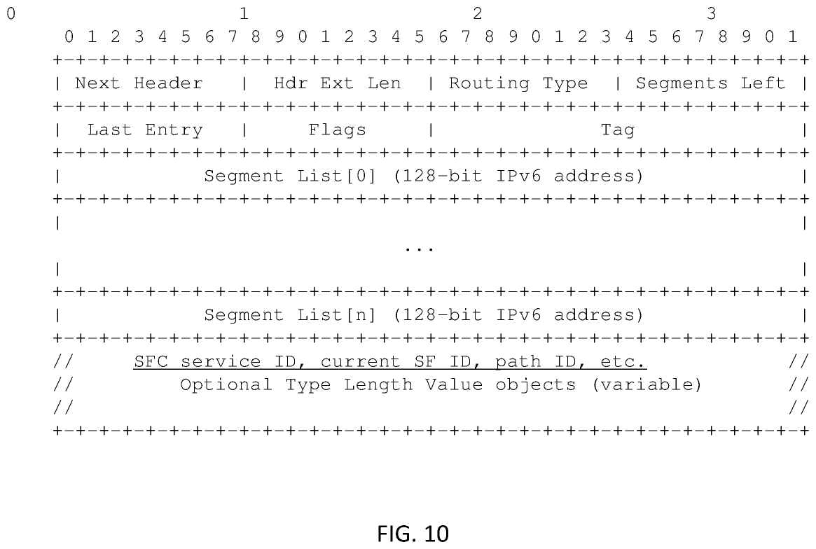

FIG. 10 illustrates a SRH with SFC in accordance with some embodiments. In this option, a modified SR header with SFC information is similar to Option 2.1 with the protocol stack in FIG. 10. The extended IPV6 SRH with SFC is shown in FIG. 10. Specifically, the SR lists in the SRH are the IPv6 addresses for the Comm SFs and the SR lists are not used to identify SFs. The information about SFs is embedded in the TLV fields in SRH. In this case, the Comm SF receives the SRH encapsulated PDU and use the information in the type-length-value (TLV) fields about SFC to steer the traffic to SFs. Alternatively, a combo-header of SFC encapsulation over SR can be used to steer the traffic similar to the name server host SR (NSHoSR), but the SFC service encapsulation is not necessarily NSH for cellular network.

Option 3: Traffic Steering with SFC Inherent SR

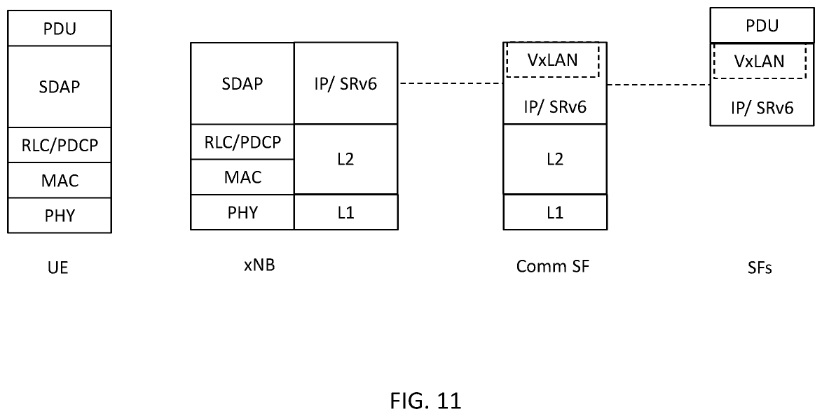

FIG. 11 illustrates a user plane stack for SFC inherent SR in accordance with some embodiments. In this option, the SFC related information is built into the SR segment list in the SR-MPLS or SRv6 header. The protocol stack is shown in FIG. 11. In this case, the SFC information is reflected as a series of SR labels to steer the traffic towards Comm SFs and SFs reachable from those Comm SFs.

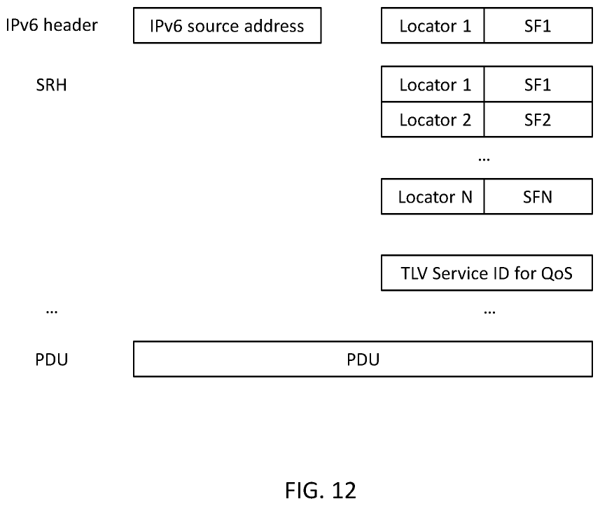

A segment list in the SRH shown in FIG. 9 is a list of IPV6 addresses, each of which can be represented as locator:function. In this case, the locator is the identifier of the Comm SF and the function is the identifier of the SFs. FIG. 12 illustrates a packet format for SFC inherent SR in accordance with some embodiments.

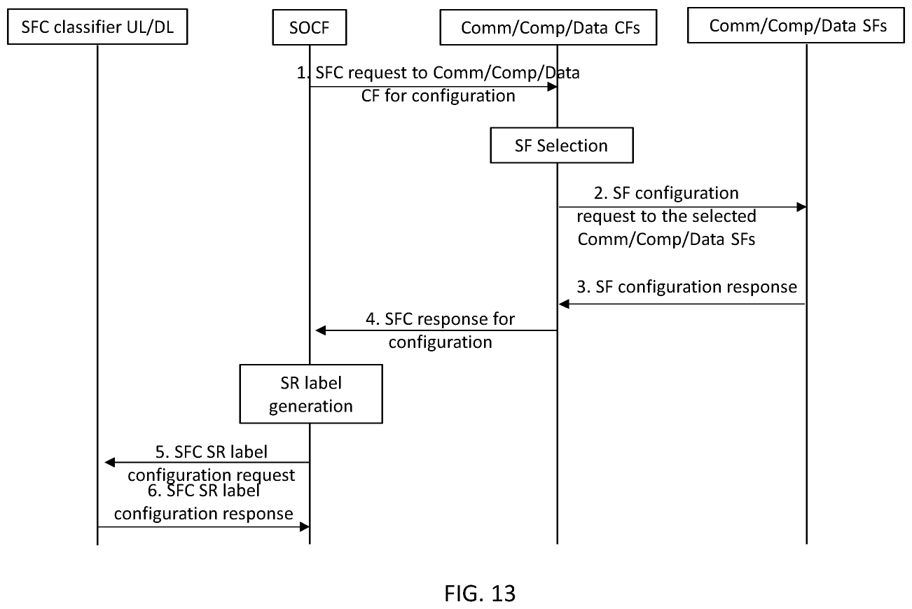

The IPV6 source address is the classifier's IP address, e.g., the xNB for UL. The Comm SF IP addresses or identifiers are the locators and the SF's identifiers are the SF names in the SRH. Additional cellular network related information such as QoS identifier, service ID, additional metadata for SFC, etc. can be put into the TLV field in SRH. The SRH can be generated at the time of SFC service set up and attach to the PDU as a result of the SFC classification. For UL traffic, the service ID, QoS identifier and metadata if any in the SDAP header may be put into the TLV field of the SRH. FIG. 13 illustrates a label configuration for SFC inherent SR in accordance with some embodiments. In particular, the procedure to set up SFC and configure SR labels to the SFC classifier is shown in FIG. 13. The SFC classifier is a function to classify traffic and attach the SR labels to the traffic, which can be in the xNB or Comm SF. For the same SFC service, the UL/DL classifier can be in different entities.

As shown in FIG. 13, at operation 1), based on the requirements from the UE/NF, the SOCF sends a request to the Comm/Comp/Data CFs about the SFC requirements on the planes respectively. For example, the request can include the number of Comm SF types, domain, processing rate, etc. for Comm CF; the requirements on the status of Computing (Comp) SF such as resource occupancy: the requirements on the data plane processing functions such as pre-processing and labeling.

At operation 2), the Comm/Comp/Data CFs perform SF selection (or bring up new instances/tasks) based on the requirements from the SOCF. The Comm/Comp/Data CFs then configure the Comm/Comp/Data SFs with the following information (but not limited to): the SFC session related information such as session ID, type, QoS, etc., the SFC packet filter and traffic processing rules: and the parameters to the Comm/Comp/Data SFs, such as input for an AI inference as a computing task.

At operation 3), the Comm/Comp/Data SFs respond with the status of the configuration and related metadata, security keys, etc. associated with the SFC configuration.

At operation 4), the Comm/Comp/Data CFs respond with the following information to the SOCF (but not limited to): the identifiers of the Comp/Comm/Data SFs: the sequence of the Comp/Comm/Data SFs: and the related configuration such as metadata, security keys about how to access the SFs.

At operation 5), the SOCF generates the SR labels based on the information from the Comp/Comm/Data CFs when setting up the SFC and sends a request to the SFC classifier to configure the SR label.

At operation 6), the SFC classifier respond with the status of the configuration. Once configured, the classifier can apply the label to the traffic.

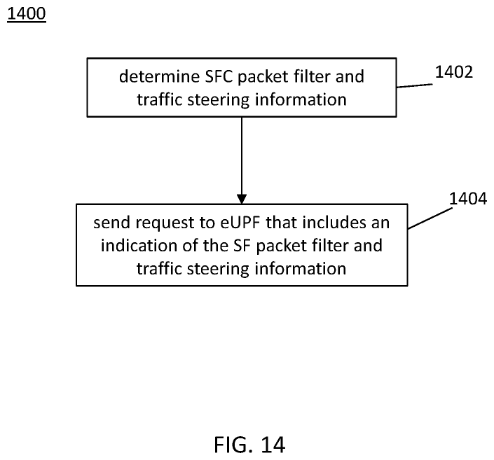

FIG. 14 illustrates a method of providing traffic steering information in accordance with some embodiments. Only some of the operations are shown, for convenience. Other operations may be present. At operation 1402 of the method 1400, SFC packet filter and traffic steering information may be determined. At operation 1404, a request may be sent to an eUPF. The request may include an indication of the SF packet filter and traffic steering information.

### EXAMPLES

Example 1 is an apparatus for a Service Orchestration and Chaining Function (SOCF) configured for operation in a 6th generation (6G) network, the apparatus comprising: processing circuitry to configure the SOCF to orchestrate and configure Service Functions (SFs), the processing circuitry to: send, to a control function (CF), a Service Function Chaining (SFC) request for the CF to perform SF selection and configure the SFs: receive, from the CF in response to transmission of the SFC request, an SFC response that includes, information of the SFs: generate, based on information in the SFC response, a Segment Routing (SR) label: send, to a SFC classifier, an SR label request to configure the SR label: and receive, from the SFC classifier in response to transmission of the SR label request, an SR label response that includes a status of a configuration of the SR label: and a memory configured to store the information of the SFs.

In Example 2, the subject matter of Example 1 includes, wherein the SFC request includes: a number of communication (Comm) SF types, domain, and processing rate for Comm CF, requirements on a status of a Comp SF, including resource occupancy, and requirements on a data SF including pre-processing and labeling.

In Example 3, the subject matter of Examples 1-2 includes, wherein at least one of: a configuration of each of the SFs includes: SFC session-related information including a session identifier (ID), a session type, and quality of service (QOS): SFC packet filter and traffic processing rules: and parameters of the SF, or the information of each of the SFs includes: an identifier (ID) of the SF, a sequence of the SF, metadata associated with the SF, and a security key to access the SF.

In Example 4, the subject matter of Examples 1-3 includes, wherein a Radio Access Network NodeB (xNB) or an enhanced user plane function (eUPF) provides the SFC classifier.

In Example 5, the subject matter of Examples 1-4 includes, wherein: an SFC service layer is a protocol layer above a SFC transport layer, and the SFC service layer is configured to hold SFC-related information, which includes path information and an ordered list of SFs, in addition to quality of service (QOS), and provide SFC encapsulation.

In Example 6, the subject matter of Example 5 includes, wherein the SFC encapsulation includes: a service identifier (ID), an ordered list of SFs that includes at least one of a list of SF names, addresses, SF service names, and Fully Qualified Domain Names (FQDNs), SFC path information that includes at least one of identifiers of path transport end points, a network slice ID Single-Network Slice Selection Assistance Information (S-NSSAI), and a current serving SF ID.

In Example 7, the subject matter of Examples 1-6 includes, wherein traffic steering rules for an SFC path that includes a plurality of at least one of Radio Access Network NodeBs (xNBs), enhanced user plane function (eUPFs), and Communication (Comm) SFs are provided in the SR label request, and the traffic steering rules include at least one of: identifiers of a destination for packets to be forwarded, whether to skip a particular SF based on network status, whether to split traffic to different SF instances based on the network status, and a next function to which to steer traffic along the SFC path.

In Example 8, the subject matter of Examples 1-7 includes, wherein: traffic steering rules are provided as SFC packet filters in a SFC service layer of the SFC classifier, and the SFC service layer is independent of an underlying transport network, and the SFC service layer is at a packet data unit (PDU) layer.

In Example 9, the subject matter of Examples 1-8 includes, wherein: traffic steering rules are provided as SFC packet filters in a SFC service layer of the SFC classifier, and the SFC service layer is independent of an underlying transport network, and the processing circuitry is to configure the SFC packet filters at a time of setting up SFC service or packet data unit (PDU) sessions.

In Example 10, the subject matter of Examples 1-9 includes, wherein: traffic steering rules are provided as SFC packet filters in a SFC service layer of the SFC classifier, and the SFC service layer is independent of an underlying transport network, and the processing circuitry is to configure different SFC packet filters into different enhanced user plane functions (eUPFs) to steer traffic through SFs that are reachable from each of the eUPFs.

In Example 11, the subject matter of Examples 1-10 includes, wherein: traffic steering rules are provided as SFC packet filters in a SFC service layer of the SFC classifier, and the SFC service layer is independent of an underlying transport network, and the SFC packet filter comprises at least one of: information in the SFC service layer, transport identifiers for a traffic path, source and destination internet protocol (IP) address or IPv6 prefix, source and destination port number, protocol identifier (ID) of a protocol above an IP or next header type, a type of service or traffic class and mask, a flow label, a security parameter index, and a packet filter direction.

In Example 12, the subject matter of Examples 1-11 includes, wherein: traffic steering rules are provided as SFC packet filters in a SFC service layer of the SFC classifier, and the SFC service layer is independent of an underlying transport network, and the processing circuitry is to configure a session management function (SMF) to configure an enhanced user plane function (eUPF) with SFC packet filter and SF forwarding rules using a Packet Forwarding Control Protocol (PFCP) with tunnel endpoint identifiers (TEIDs) as the SR labels.

In Example 13, the subject matter of Examples 1-12 includes, wherein: the processing circuitry is to configure a communication (Comm) control function (CF) to configure a Comm SF with at least one of a SFC packet filter and SF forwarding rules using at least one of: a PFCP, Path Computation Element Protocol (PCEP), OpenFlow, or Netconf protocol, with SR-MultiProtocol Label Switching (SR-MPLS) or SRv6 labels as the SR labels, and a General Packet Radio Service (GPRS) Tunneling Protocol (GTP)-user (GTP-U) header contains SFC-related information at or after octet 12, the SFC-related information comprising at least one of a service identifier (ID), a path ID, and a current SF.

In Example 14, the subject matter of Examples 1-13 includes, wherein: the processing circuitry is to configure a communication (Comm) control function (CF) to configure a Comm SF with at least one of a SFC packet filter and SF forwarding rules using at least one of: a PFCP, Path Computation Element Protocol (PCEP), OpenFlow, or Netconf protocol, with SR-MultiProtocol Label Switching (SR-MPLS) or SRv6 labels as the SR labels, and an IPV6 Segment Routing Header (SRH) has type-length-value (TLV) fields that contains SFC-related information, the SFC-related information comprising at least one of a service identifier (ID), a path ID, and a current SF.

In Example 15, the subject matter of Examples 1-14 includes, wherein: the processing circuitry is to configure a communication (Comm) control function (CF) to configure a Comm SF with at least one of a SFC packet filter and SF forwarding rules using at least one of: a PFCP, Path Computation Element Protocol (PCEP), OpenFlow, or Netconf protocol, with SR-MultiProtocol Label Switching (SR-MPLS) or SRv6 labels as the SR labels, and a SR-MultiProtocol Label Switching (SR-MPLS) or SRv6 header includes SFC-related information, the SFC-related information comprising a series of SR labels to steer traffic towards Comm SFs and SFs reachable from the Comm SFs.

In Example 16, the subject matter of Examples 1-15 includes, wherein: the processing circuitry is to configure a communication (Comm) control function (CF) to configure a Comm SF with at least one of a SFC packet filter and SF forwarding rules using at least one of: a PFCP, Path Computation Element Protocol (PCEP), OpenFlow, or Netconf protocol, with SR-MultiProtocol Label Switching (SR-MPLS) or SRv6 labels as the SR labels, and first SFC-related information is carried as a locator: function field in Segment Routing Header (SRH) and second SFC-related information is contained in a type-length-value (TLV) field of the SRH, the first SFC-related information comprising the Comm SF and identification of SFs reachable from the Comm SF.

Example 17 is an apparatus for a Radio Access Network NodeB (xNB) configured for operation in a 6th generation (6G) network, the apparatus comprising: processing circuitry to configure the xNB to: receive traffic forwarding rules provided by a Service Orchestration and Chaining Function (SOCF), the traffic forwarding rules to steer traffic to different Service Functions (SFs) based on identifiers of the SFs: receive data from a user equipment (UE); and steer the data for Service Function Chaining (SFC) on a user plane based on the traffic forwarding rules: and a memory configured to store the traffic forwarding rules.

In Example 18, the subject matter of Example 17 includes, wherein the processing circuitry is to use at least one of: separate SFC service layer and transport protocols in which transport uses identifiers of different enhanced user plane functions (eUPFs) and communication (Comm) SFs, transport protocols that are integrated with SFC-related information in which a General Packet Radio Service (GPRS) Tunneling Protocol (GTP)-user (GTP-U) header or a Segment Routing Header (SRH) has type-length-value (TLV) fields contains the SFC-related information, and an SFC inherent SR protocol stack in which first SFC-related information is carried as a locator: function field in Segment Routing Header (SRH) and second SFC-related information is contained in a type-length-value (TLV) field of the SRH, the first SFC-related information comprising a particular Comm SF and identification of SFs reachable from the particular Comm SF.

Example 19 is a non-transitory computer-readable storage medium that stores instructions for execution by one or more processors of a Service Orchestration and Chaining Function (SOCF) configured for operation in a 6th generation (6G) network, the one or more processors to configure the SOCF to, when the instructions are executed: send, to a control function (CF), a Service Function Chaining (SFC) request for the CF to perform Service Function (SF) selection and configure the SFs: receive, from the CF in response to transmission of the SFC request, an SFC response that includes, information of the SFs: generate, based on information in the SFC response, a Segment Routing (SR) label: send, to a SFC classifier, an SR label request to configure the SR label: and receive, from the SFC classifier in response to transmission of the SR label request, an SR label response that includes a status of a configuration of the SR label.

In Example 20, the subject matter of Example 19 includes, wherein the instructions, when executed, further configure the SOCF to use at least one of: separate SFC service layer and transport protocols in which transport uses identifiers of different enhanced user plane functions (eUPFs) and communication (Comm) SFs, transport protocols that are integrated with SFC-related information in which a General Packet Radio Service (GPRS) Tunneling Protocol (GTP)-user (GTP-U) header or a Segment Routing Header (SRH) has type-length-value (TLV) fields contains the SFC-related information, and an SFC inherent SR protocol stack in which first SFC-related information is carried as a locator: function field in Segment Routing Header (SRH) and second SFC-related information is contained in a type-length-value (TLV) field of the SRH, the first SFC-related information comprising a particular Comm SF and identification of SFs reachable from the particular Comm SF.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Any one or more of the examples or embodiments may be combined as desired.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-20. (canceled)

21. An apparatus for a Service Orchestration and Chaining Function (SOCF) configured for operation in a 6^{th} generation (6G) network, the apparatus comprising:
processing circuitry to configure the SOCF to orchestrate and configure Service Functions (SFs), the processing circuitry to:
send, to a control function (CF), a Service Function Chaining (SFC) request for the CF to perform SF selection and configure the SFs;
receive, from the CF in response to transmission of the SFC request, an SFC response that includes information of the SFs;
generate, based on information in the SFC response, a Segment Routing (SR) label;
send, to a SFC classifier, an SR label request to configure the SR label; and
receive, from the SFC classifier in response to transmission of the SR label request, an SR label response that includes a status of a configuration of the SR label; and a memory configured to store the information of the SFs.

22. The apparatus of claim 21, wherein the SFC request includes:
a number of communication (Comm) SF types, domain, and processing rate for Comm CF,
requirements on a status of a Comp SF, including resource occupancy, and
requirements on a data SF including pre-processing and labeling.

23. The apparatus of claim 21, wherein at least one of:
a configuration of each of the SFs includes: SFC session-related information including a session identifier (ID), a session type, and quality of service (QOS); SFC packet filter and traffic processing rules; and parameters of the SF, or
the information of each of the SFs includes: an identifier (ID) of the SF, a sequence of the SF, metadata associated with the SF, and a security key to access the SF.

24. The apparatus of claim 21, wherein a Radio Access Network NodeB (xNB) or an enhanced user plane function (eUPF) provides the SFC classifier.

25. The apparatus of claim 21, wherein:
an SFC service layer is a protocol layer above a SFC transport layer, and
the SFC service layer is configured to hold SFC-related information, which includes path information and an ordered list of SFs, in addition to quality of service (QOS), and provide SFC encapsulation.

26. The apparatus of claim 25, wherein the SFC encapsulation includes:
a service identifier (ID),
an ordered list of SFs that includes at least one of a list of SF names, addresses, SF service names, and Fully Qualified Domain Names (FQDNs),
SFC path information that includes at least one of identifiers of path transport end points, a network slice ID Single—Network Slice Selection Assistance Information (S-NSSAI), and
a current serving SF ID.

27. The apparatus of claim 21, wherein traffic steering rules for an SFC path that includes a plurality of at least one of Radio Access Network NodeBs (xNBs), enhanced user plane function (eUPFs), and Communication (Comm) SFs are provided in the SR label request, and the traffic steering rules include at least one of: identifiers of a destination for packets to be forwarded, whether to skip a particular SF based on network status, whether to split traffic to different SF instances based on the network status, and a next function to which to steer traffic along the SFC path.

28. The apparatus of claim 21, wherein:
traffic steering rules are provided as SFC packet filters in a SFC service layer of the SFC classifier, and the SFC service layer is independent of an underlying transport network, and
the SFC service layer is at a packet data unit (PDU) layer.

29. The apparatus of claim 21, wherein:
traffic steering rules are provided as SFC packet filters in a SFC service layer of the SFC classifier, and the SFC service layer is independent of an underlying transport network, and
the processing circuitry is to configure the SFC packet filters at a time of setting up SFC service or packet data unit (PDU) sessions.

30. The apparatus of claim 21, wherein:
traffic steering rules are provided as SFC packet filters in a SFC service layer of the SFC classifier, and the SFC service layer is independent of an underlying transport network, and
the processing circuitry is to configure different SFC packet filters into different enhanced user plane functions (eUPFs) to steer traffic through SFs that are reachable from each of the eUPFs.

31. The apparatus of claim 21, wherein:
traffic steering rules are provided as SFC packet filters in a SFC service layer of the SFC classifier, and the SFC service layer is independent of an underlying transport network, and
each SFC packet filter comprises at least one of: information in the SFC service layer, transport identifiers for a traffic path, source and destination internet protocol (IP) address or IPv6 prefix, source and destination port number, protocol identifier (ID) of a protocol above an IP or next header type, a type of service or traffic class and mask, a flow label, a security parameter index, and a packet filter direction.

32. The apparatus of claim 21, wherein:
traffic steering rules are provided as SFC packet filters in a SFC service layer of the SFC classifier, and the SFC service layer is independent of an underlying transport network, and
the processing circuitry is to configure a session management function (SMF) to configure an enhanced user plane function (eUPF) with SFC packet filter and SF forwarding rules using a Packet Forwarding Control Protocol (PFCP) with tunnel endpoint identifiers (TEIDs) as SR labels.

33. The apparatus of claim 21, wherein:
the processing circuitry is to configure a communication (Comm) control function (CF) to configure a Comm SF with at least one of a SFC packet filter and SF forwarding rules using at least one of: a PFCP, Path Computation Element Protocol (PCEP), OpenFlow, or Netconf protocol, with SR-MultiProtocol Label Switching (SR-MPLS) or SRv6 labels as SR labels, and
a General Packet Radio Service (GPRS) Tunneling Protocol (GTP)-user (GTP-U) header contains SFC-related information at or after octet 12, the SFC-related information comprising at least one of a service identifier (ID), a path ID, and a current SF.

34. The apparatus of claim 21, wherein:
the processing circuitry is to configure a communication (Comm) control function (CF) to configure a Comm SF with at least one of a SFC packet filter and SF forwarding rules using at least one of: a PFCP, Path Computation Element Protocol (PCEP), OpenFlow, or Netconf protocol, with SR-MultiProtocol Label Switching (SR-MPLS) or SRv6 labels as SR labels, and
an IPV6 Segment Routing Header (SRH) has type-length-value (TLV) fields that contains SFC-related information, the SFC-related information comprising at least one of a service identifier (ID), a path ID, and a current SF.

35. The apparatus of claim 21, wherein:
the processing circuitry is to configure a communication (Comm) control function (CF) to configure a Comm SF with at least one of a SFC packet filter and SF forwarding rules using at least one of: a PFCP, Path Computation Element Protocol (PCEP), OpenFlow, or Netconf protocol, with SR-MultiProtocol Label Switching (SR-MPLS) or SRv6 labels as SR labels, and
a SR-MPLS or SRv6 header includes SFC-related information, the SFC-related information comprising a series of SR labels to steer traffic towards Comm SFs and SFs reachable from the Comm SFs.

36. The apparatus of claim 21, wherein:
the processing circuitry is to configure a communication (Comm) control function (CF) to configure a Comm SF with at least one of a SFC packet filter and SF forwarding rules using at least one of: a PFCP, Path Computation Element Protocol (PCEP), OpenFlow, or Netconf protocol, with SR-MultiProtocol Label Switching (SR-MPLS) or SRv6 labels as SR labels, and
first SFC-related information is carried as a locator: function field in Segment Routing Header (SRH) and second SFC-related information is contained in a type-length-value (TLV) field of the SRH, the first SFC-related information comprising the Comm SF and identification of SFs reachable from the Comm SF.

37. An apparatus for a Radio Access Network NodeB (xNB) configured for operation in a 6^{th} generation (6G) network, the apparatus comprising:
processing circuitry to configure the xNB to:
receive traffic forwarding rules provided by a Service Orchestration and Chaining Function (SOCF), the traffic forwarding rules to steer traffic to different Service Functions (SFs) based on identifiers of the SFs;
receive data from a user equipment (UE); and
steer the data for Service Function Chaining (SFC) on a user plane based on the traffic forwarding rules; and
a memory configured to store the traffic forwarding rules.

38. The apparatus of claim 37, wherein the processing circuitry is to use at least one of:
separate SFC service layer and transport protocols in which transport uses identifiers of different enhanced user plane functions (eUPFs) and communication (Comm) SFs,
transport protocols that are integrated with SFC-related information in which a General Packet Radio Service (GPRS) Tunneling Protocol (GTP)-user (GTP-U) header or a Segment Routing Header (SRH) has type-length-value (TLV) fields contains the SFC-related information, and
an SFC inherent SR protocol stack in which first SFC-related information is carried as a locator: function field in Segment Routing Header (SRH) and second SFC-related information is contained in a type-length-value (TLV) field of the SRH, the first SFC-related information comprising a particular Comm SF and identification of SFs reachable from the particular Comm SF.

39. A non-transitory computer-readable storage medium that stores instructions for execution by one or more processors of a Service Orchestration and Chaining Function (SOCF) configured for operation in a 6^{th} generation (6G) network, the one or more processors to configure the SOCF to, when the instructions are executed:
send, to a control function (CF), a Service Function Chaining (SFC) request for the CF to perform Service Function (SF) selection and configure SFs;
receive, from the CF in response to transmission of the SFC request, an SFC response that includes information of the SFs;
generate, based on information in the SFC response, a Segment Routing (SR) label;
send, to a SFC classifier, an SR label request to configure the SR label; and
receive, from the SFC classifier in response to transmission of the SR label request, an SR label response that includes a status of a configuration of the SR label.

40. The non-transitory computer-readable storage medium of claim 39, wherein the instructions, when executed, further configure the SOCF to use at least one of:
separate SFC service layer and transport protocols in which transport uses identifiers of different enhanced user plane functions (eUPFs) and communication (Comm) SFs,
transport protocols that are integrated with SFC-related information in which a General Packet Radio Service (GPRS) Tunneling Protocol (GTP)-user (GTP-U) header or a Segment Routing Header (SRH) has type-length-value (TLV) fields contains the SFC-related information, and
an SFC inherent SR protocol stack in which first SFC-related information is carried as a locator: function field in Segment Routing Header (SRH) and second SFC-related information is contained in a type-length-value (TLV) field of the SRH, the first SFC-related information comprising a particular Comm SF and identification of SFs reachable from the particular Comm SF.
